(19) United States
(12) Patent Application Publication
(10) Pub. No.: US 2026/0186268 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventor: Ronghui Cai, Changzhou (CN)

(21) Appl. No.: 19/300,602

(22) Filed: Aug. 14, 2025

Related U.S. Application Data
(63) Continuation of application No. PCT/CN2024/144454, filed on Dec. 31, 2024.

(51) Int. Cl. G02B 13/00; G02B 9/60

(52) U.S. Cl. CPC G02B 13/0065; G02B 9/60; G02B 13/0045

(57) ABSTRACT

The present disclosure relates to a camera optical lens, including, from an object side to an image side in sequence, a first lens, a second lens, a third lens, a fourth lens, and a fifth lens. The camera optical lens satisfies: 1.90≤fA*IH/TTL≤2.20, 0.25≤Lp/TTL≤0.41, 0.00≤Rp1/Rp2≤1.11, and 3.00≤(R9+R10)/(R9−R10)≤30.20, where fA represents a maximum focal length of the camera optical lens, Lp represents a distance between the first lens and the fifth lens in a first state of the camera optical lens, Rp1 and Rp2 represent a curvature radius of the object side surface and a curvature radius of the image side surface of the first prism, respectively, and R9 and R10 represent a curvature radius of an object side surface and a curvature radius of an image side surface of the fifth lens, respectively.

### CROSS REFERENCE TO RELATED APPLICATIONS

The present application is a continuation of PCT Patent Application No. PCT/CN2024/144454, entitled “CAMERA OPTICAL LENS,” filed on Dec. 31, 2024, which is incorporated herein by reference in its entirety.

### TECHNICAL FIELD

The present disclosure relates to the field of optical lens, and in particular to a camera optical lens.

### BACKGROUND

With the emergence of smart devices in recent years, the demand for miniature camera lenses is increasing day by day, but the pixel size of the photosensitive devices is shrinking due to the improvement of semiconductor manufacturing technologies, coupled with the current development trend of electronic products being that their functions should be better and their shape should be thin and small, miniature camera lens with good imaging quality therefor has become a mainstream in the market.

With the development of technology and the increase of the diverse demands of users, and under the circumstances that the pixel area of photosensitive devices is shrinking steadily and the requirement of the system for the imaging quality is improving constantly, three-piece lens structures, four-piece lens structures, or even five-piece lens structures gradually appear in lens design. However, with the development of technology and the increase of the diverse demands of users, and under the circumstances that the pixel area of photosensitive devices is shrinking steadily and the requirement of the system for the imaging quality is improving constantly, six-piece lens structures gradually appear in lens design. Although common six-piece lenses have good optical performance, their optical power, spacing between lenses, and lens shapes still have certain irrationality, resulting in lens structures that cannot meet the design requirements of long focal lengths, high magnification, and miniaturization while having good optical performance.

### SUMMARY

The present disclosure is intended to provide a camera optical lens that can meet the design requirements of long focal lengths, high magnification, and miniaturization while having good imaging performance.

To this end, the present disclosure provide a camera optical lens, including, from an object side to an image side in sequence, a first prism with a positive refractive power, a first lens with a negative refractive power, a second lens with a positive refractive power, a third lens with a negative refractive power, a fourth lens with a positive refractive power, and a fifth lens. A reflective surface is provided between an object side surface and an image side surface of the first prism, and the first lens, the second lens, the third lens, the fourth lens, and the fifth lens form a lens assembly movable and adjustable along an optical axis of the camera optical lens, allowing the camera optical lens switchable between a first state and a second state. The camera optical lens has a maximum focal length in the first state and has a minimum focal length in the second state.

The camera optical lens satisfies the following conditions: 1.90≤fA*IH/TTL≤2.20, 0.25≤Lp/TTL≤0.41, 0.00≤Rp1/Rp2≤1.11, and 3.00≤(R9+R10)/(R9−R10)≤30.20, where fA represents a focal length of the camera optical lens in the first state, IH represents an image height of 1.0H of the camera optical lens, Lp represents a distance, along the optical axis, between a surface of a lens closest to the object side and a surface of a lens closest to the image side in the first state of the camera optical lens, Rp1 represents a curvature radius of the object side surface of the first prism, Rp2 represents a curvature radius of the image side surface of the first prism, R9 represents a curvature radius of an object side surface of the fifth lens, R10 represents a curvature radius of an image side surface of the fifth lens, and TTL represents a total track length of the camera optical lens.

As an improvement, the camera optical lens further satisfies the following condition: 2.40≤(d1+d3+d5)/(d7+d9)≤3.00, where d1 represents an on-axis thickness of the first lens, d3 represents an on-axis thickness of the second lens, d5 represents an on-axis thickness of the third lens, d7 represents an on-axis thickness of the fourth lens, and d9 represents an on-axis thickness of the fifth lens.

As an improvement, the object side surface of the first prism is convex in a paraxial region, and the camera optical lens further satisfies the following condition: 3.22≤fp1/fA≤7.98, and 0.322≤dp1/TTL≤0.363, where fp1 represents a focal length of the first prism, and dp1 represents a sum of an on-axis distance between the object side surface of the first prism and the reflective surface and an on-axis distance between the reflective surface and the image side surface of the first prism.

As an improvement, an object side surface of the first lens is convex in a paraxial region, and an image side surface of the first lens is concave in the paraxial region. The camera optical lens further satisfies the following condition: −0.80≤f1/fA≤−0.57, 2.83≤(R1+R2)/(R1−R2)≤3.48, and 0.029≤d1/TTL≤0.060, where f1 represents a focal length of the first lens, R1 represents a curvature radius of an object side surface of the first lens, R2 represents a curvature radius of an image side surface of the first lens, and d1 represents an on-axis thickness of the first lens.

As an improvement, an object side surface of the second lens is convex in a paraxial region, and an image side surface of the second lens is concave in the paraxial region. The camera optical lens further satisfies the following conditions: 0.34≤f2/fA≤0.41, −0.96≤(R3+R4)/(R3−R4)≤−0.67, and 0.067≤d3/TTL≤0.084, where f2 represents a focal length of the second lens, R3 represents a curvature radius of the object side surface of the second lens, R4 represents a curvature radius of the image side surface of the second lens, and d3 represents an on-axis thickness of the second lens.

As an improvement, the camera optical lens further satisfies the following conditions: −15.12≤f3/fA≤−0.86, −1.74≤(R5+R6)/(R5−R6)≤2.02, and 0.048≤d5/TTL≤0.078, where f3 represents a focal length of the third lens, R5 represents a curvature radius of the object side surface of the third lens, R6 represents a curvature radius of an image side surface of the third lens, and d5 represents an on-axis thickness of the third lens.

As an improvement, the object side surface of the fourth lens is convex in a paraxial region, and the image side surface of the fourth lens is concave in the paraxial region. The camera optical lens further satisfies the following conditions: 1.09≤f4/fA≤2.50, −10.76≤(R7+R8)/(R7−R8)≤−2.02, and 0.037≤d7/TTL≤0.042, where f4 represents a focal length of the fourth lens, R7 represents a curvature radius of the object side surface of the fourth lens, R8 represents a curvature radius of an image side surface of the fourth lens, and d7 represents an on-axis thickness of the fourth lens.

As an improvement, an object side surface of the fifth lens is convex in a paraxial region, and an image side surface of the fifth lens is concave in the paraxial region. The camera optical lens further satisfies the following conditions: −8.59≤f5/fA≤494.45, and 0.027≤d9/TTL≤0.051, where f5 represents a focal length of the fifth lens, R9 represents a curvature radius of the object side surface of the fifth lens, R10 represents a curvature radius of an image side surface of the fifth lens, and d9 represents an on-axis thickness of the fifth lens.

As an improvement, the first prism is made of glass.

The beneficial effects of the present disclosure are: the camera optical lens provided in the present disclosure can achieve internal focusing based on the movement of its lens group, thereby having excellent optical performance and the characteristics of long focal lengths, high magnification, and miniaturization.

### BRIEF DESCRIPTION OF DRAWINGS

FIG. 1 is a schematic diagram of a structure of a camera optical lens 10 that is in a first state according to a first embodiment of the present disclosure.

FIG. 2 is a schematic diagram of a lateral color of the camera optical lens 10 shown in FIG. 1.

FIG. 3 is a schematic diagram of a longitudinal aberration of the camera optical lens 10 shown in FIG. 1.

FIG. 4 is a schematic diagram of a field curvature and a distortion of the camera optical lens 10 shown in FIG. 1.

FIG. 5 is a schematic diagram of a structure of a camera optical lens 20 that is in the first state according to a second embodiment of the present disclosure.

FIG. 6 is a schematic diagram of a lateral color of the camera optical lens 20 shown in FIG. 5.

FIG. 7 is a schematic diagram of a longitudinal aberration of the camera optical lens 20 shown in FIG. 5.

FIG. 8 is a schematic diagram of a field curvature and a distortion of the camera optical lens 20 shown in FIG. 5.

FIG. 9 is a schematic diagram of a structure of a camera optical lens 30 that is in the first state according to a third embodiment of the present disclosure.

FIG. 10 is a schematic diagram of a lateral color of the camera optical lens 30 shown in FIG. 9.

FIG. 11 is a schematic diagram of a longitudinal aberration of the camera optical lens 30 shown in FIG. 9.

FIG. 12 is a schematic diagram of a field curvature and a distortion of the camera optical lens 30 shown in FIG. 9.

FIG. 13 is a schematic diagram of a structure of a camera optical lens 40 that is in the first state according to a fourth embodiment of the present disclosure.

FIG. 14 is a schematic diagram of a lateral color of the camera optical lens 40 shown in FIG. 13.

FIG. 15 is a schematic diagram of a longitudinal aberration of the camera optical lens 40 shown in FIG. 13.

FIG. 16 is a schematic diagram of a field curvature and a distortion of the camera optical lens 40 shown in FIG. 13.

FIG. 17 is a schematic diagram of a structure of a camera optical lens 50 that is in the first state according to a fifth embodiment of the present disclosure.

FIG. 18 is a schematic diagram of a lateral color of the camera optical lens 50 shown in FIG. 17.

FIG. 19 is a schematic diagram of a longitudinal aberration of the camera optical lens 50 shown in FIG. 17.

FIG. 20 is a schematic diagram of a field curvature and a distortion of the camera optical lens 50 shown in FIG. 17.

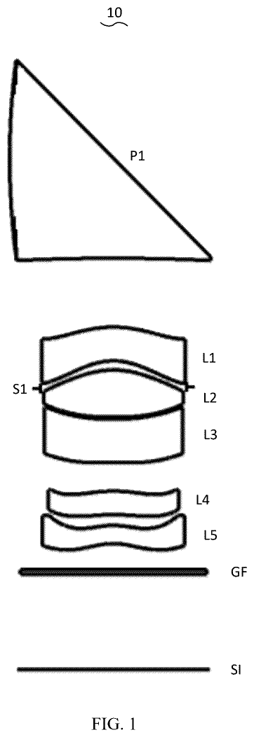

### DETAILED DESCRIPTION OF EMBODIMENTS

In the following, clear and complete illustration of the technical solutions in the embodiments of the present disclosure is provided. It is obvious that the illustrated embodiments are only some embodiments of the present disclosure, not all of them. Other embodiments derived based on the embodiments of the present disclosure by those of ordinary skill in the art without any inventive effort all fall into the scope of protection of the present disclosure.

The present disclosure provides camera optical lenses 10, 20, 30, 40, and 50. Each of the camera optical lenses 10, 20, 30, 40, and 50 includes, from an object side to an image side in sequence, a first prism P1 with a positive refractive power, a first lens L1 with a negative refractive power, a second lens L2 with a positive refractive power, a third lens L3 with a negative refractive power, a fourth lens L4 with a positive refractive power, and a fifth lens L5 with a positive refractive power. A reflective surface is provided between an object side surface and an image side surface of the first prism P1.

The first lens L1, the second lens L2, the third lens L3, the fourth lens L4, and the fifth lens L5 form a lens assembly movable and adjustable along an optical axis of the camera optical lenses 10, 20, 30, 40, and 50, allowing the camera optical lenses 10, 20, 30, 40, and 50 switchable between a first state and a second state. The camera optical lenses 10, 20, 30, 40, and 50 has a maximum focal length in the first state and has a minimum focal length in the second state.

The lens assembly is arranged between the first prism P1 and an image plane SI, and is movable along the optical axis of the camera optical lenses 10, 20, 30, 40, and 50, so that the on-axis distance between the image side surface of the first prism P1 and the object side surface of the lens assembly, as well as the on-axis distance between the image side surface of the lens assembly and the image plane, are adjustable. In this way, the lens assembly is implemented as a movable zoom set, and with the movement of the lens assembly, the focal lengths of the camera optical lenses 10, 20, 30, 40, and 50 are variable, thereby providing good imaging effects in both the first and second states of the camera optical lenses 10, 20, 30, 40, and 50. Herein, the first state refers to a state in which each of the camera optical lenses 10, 20, 30, 40, and 50 has a maximum focal length, and the second state refers to a state in which each of the camera optical lenses 10, 20, 30, 40, and 50 has a minimum focal length. For example, the first state may be either a telephoto state or an infinity focus state, and the second state may be either a wide-angle state or a macro state. In this way, internal focusing of the camera optical lenses 10, 20, 30, 40, and 50 can be achieved based on the movable focusing of the lens assembly.

Each of the camera optical lenses 10, 20, 30, 40, and 50 satisfies the following condition: 1.90≤fA*IH/TTL≤2.20, where fA represents a focal length of the camera optical lenses 10, 20, 30, 40, and 50 in the first state, IH represents an image height of 1.0H of the camera optical lenses 10, 20, 30, 40, and 50, and TTL represents a total track length of the camera optical lenses 10, 20, 30, 40, and 50. By stipulating a ratio of a product of the focal length and image height of the optical system to the total track length, the optical system can have a greater focal length when the image height is fixed, which helps to improve the magnification of the system.

Each of the camera optical lenses 10, 20, 30, 40, and 50 further satisfies the following condition: 0.25≤Lp/TTL≤0.41, where Lp represents a distance, along the optical axis, between a surface of a lens closest to the object side and a surface of a lens closest to the image side in the first state of the camera optical lenses 10, 20, 30, 40, and 50. By stipulating a ratio of a length of the lens assembly to the total track length of each of the camera optical lenses 10, 20, 30, 40, and 50 to be within the range according the above-mentioned condition, it is conducive to reduce the total track lengths of the camera optical lenses 10, 20, 30, 40, and 50.

Each of the camera optical lenses 10, 20, 30, 40, and 50 further satisfies the following conditions: 0.00≤Rp1/Rp2≤1.11, where Rp1 represents a curvature radius of the object side surface of the first prism P1, and Rp2 represents a curvature radius of the image side surface of the first prism P1. By stipulating the shapes of the convex surface and the concave surface of the first prism P1 to be within the range according the above-mentioned condition, it is conducive to alleviating a degree of deflection of light passing through the lenses, thereby reducing aberrations effectively.

Each of the camera optical lenses 10, 20, 30, 40, and 50 further satisfies the following conditions: 3.00≤(R9+R10)/(R9−R10)≤30.20, where R9 represents a curvature radius of an object side surface of the fifth lens, and R10 represents a curvature radius of an image side surface of the fifth lens. By stipulating the shape of the fifth lens to be within the range according the above-mentioned condition, it is conducive to alleviating a degree of deflection of light passing through the lenses, thereby reducing aberrations effectively.

When the focal length, image height, and total track length of the camera optical lenses 10, 20, 30, 40, and 50, as well as the focal lengths, on-axis thicknesses, curvature radii of the lenses, satisfies the above conditions, the camera optical lenses 10, 20, 30, 40, and 50 can meet the design requirements of long focal lengths, high magnification, and miniaturization.

Based on the above conditions and the functions that can be achieved, characteristics of each lens are illustrated in detail as follows.

An on-axis thickness of the first lens L1 is defined as d1, an on-axis thickness of the second lens L2 is defined as d3, an on-axis thickness of the third lens L3 is defined as d5, an on-axis thickness of the fourth lens L4 is defined as d7, an on-axis thickness of the fifth lens L5 is defined as d9, and the camera optical lens satisfies a condition of 2.40≤(d1+d3+d5)/(d7+d9)≤3.00, which stipulates a thickness relationship of the lenses of the camera optical lenses 10, 20, 30, 40, and 50. By reasonably allocating the thicknesses of the lenses, it is conducive to reducing the assembly difficulty in the production process, and to improving yield rate.

The object side surface of the first prism P1 is convex in a paraxial region, and the image side surface of the first prism P1 is concave or planar in the paraxial region. The object side surface and the image side surface of the first prism P1 may have other shapes, respectively.

A focal length of the first prism P1 is defined as fp1, and the camera optical lens satisfies a condition of 3.22≤fp1/fA≤7.98, which stipulates the positive refractive power of the first prism P1. Within this range, it is conducive to reducing the aberration and improving the imaging quality of the camera optical lenses 10, 20, 30, 40, and 50.

A sum of an on-axis distance between the object side surface of the first prism P1 and the reflective surface and an on-axis distance between the reflective surface and the image side surface of the first prism P1 is defined as dp1, and the camera optical lens satisfies a condition of 0.322≤dp1/TTL≤0.363, which is conducive to reasonably controlling the total track lengths of the camera optical lenses.

An object side surface of the first lens L1 is convex in the paraxial region, and an image side surface of the first lens L1 is concave in the paraxial region. The object side surface and the image side surface of the first lens L1 may have other concave or convex shapes.

A focal length of the first lens L1 is defined as f1, and the camera optical lens satisfies a condition of −0.80≤f1/fA≤−0.57. By controlling the negative optical power of the first lens L1 within a reasonable range, it is conducive to correcting the aberration of the optical system.

A curvature radius of an object side surface of the first lens L1 is defined as R1, a curvature radius of an image side surface of the first lens L1 is defined as R2, and the camera optical lens satisfies a condition of 2.83≤(R1+R2)/(R1−R2)≤3.48, which stipulates a shape of the first lens L1. Within this range, a development towards miniature lenses would facilitate correcting a problem of on-axis chromatic aberration.

An on-axis thickness of the first lens L1 is defined as d1, and the camera optical lens satisfies a condition of 0.029≤d1/TTL≤0.060, which is conducive to reasonably controlling the total track lengths of the camera optical lenses.

An object side surface of the second lens L2 is convex in the paraxial region, and an image side surface of the second lens L2 is convex in the paraxial region. The object side surface and the image side surface of the second lens L2 may have other concave or convex shapes.

A focal length of the second lens L2 is defined as f2, and the camera optical lens satisfies a condition of 0.34≤f2/fA≤0.41. By reasonably allocating the optical power, the system can have an excellent imaging quality and a lower sensitivity.

A curvature radius of the object side surface of the second lens L2 is defined as R3, a curvature radius of the image side surface of the second lens L2 is defined as R4, and the camera optical lens satisfies a condition of −0.96≤(R3+R4)/(R3−R4)≤−0.67, which effectively controls a shape of the second lens L2 and facilitates formation of the second lens L2. In this way, formation defects and stress caused by excessive surface curvature of the second lens L2 can be prevented.

An on-axis thickness of the second lens L2 is defined as d3, and the camera optical lens satisfies a condition of 0.067≤d3/TTL≤0.084, which is conducive to reasonably controlling the total track lengths of the camera optical lenses.

An object side surface of the third lens L3 is concave in the paraxial region, and an image side surface of the third lens L3 is concave in the paraxial region. The object side surface and the image side surface of the third lens L3 may have other concave or convex shapes.

A focal length of the third lens L3 is defined as f3, and the camera optical lens satisfies a condition of −15.12≤f3/fA≤−0.86. By reasonably allocating the optical power, the system can have an excellent imaging quality and a lower sensitivity.

A curvature radius of the object side surface of the third lens L3 is defined as R5, a curvature radius of an image side surface of the third lens L3 is defined as R6, and the camera optical lens satisfies a condition of −1.74≤(R5+R6)/(R5−R6)≤2.02, which stipulates a shape of the third lens L3. Within this range, a development towards miniature lenses would facilitate correcting a problem of aberration at off-axis field angle.

An on-axis thickness of the third lens L3 is defined as d5, and the camera optical lens satisfies a condition of 0.048≤d5/TTL≤0.078, which stipulates a ratio of the on-axis thickness of the third lens L3 to the total track length TTL of each of the camera optical lenses 10, 20, 30, 40, and 50. In this way, it is conducive to reasonably controlling the total track lengths of the camera optical lenses.

The object side surface of the fourth lens L4 is convex in a paraxial region, and the image side surface of the fourth lens L4 is concave in the paraxial region. The object side surface and the image side surface of the fourth lens L4 may have other concave or convex shapes.

A focal length of the fourth lens L4 is defined as f4, and the camera optical lens satisfies a condition of 1.09≤f4/fA≤2.50. By defining the fourth lens L4, a light angle for the camera optical lens can be smoothed effectively and a tolerance sensitivity can be reduced.

A curvature radius of the object side surface of the fourth lens L4 is defined as R7, a curvature radius of an image side surface of the fourth lens L4 is defined as R8, and the camera optical lens satisfies a condition of −10.76≤(R7+R8)/(R7−R8)≤−2.02, which stipulates a shape of the fourth lens L4. Within this range, a development towards miniature lenses would facilitate correcting a problem of aberration at off-axis field angle.

An on-axis thickness of the fourth lens L4 is defined as d7, and the camera optical lens satisfies a condition of 0.037≤d7/TTL≤0.042, which is conducive to reasonably controlling the total track lengths of the camera optical lenses.

The fifth lens L5 has a positive or negative refractive power, an object side surface of the fifth lens L5 is convex in a paraxial region, and an image side surface of the fifth lens L5 is concave in the paraxial region. The object side surface and the image side surface of the fifth lens L5 may have other concave or convex shapes.

A focal length of the fifth lens L5 is defined as f5, and the camera optical lens satisfies a condition of −8.59≤f5/fA≤494.45. By defining the fifth lens L5, a light angle for the camera optical lens can be smoothed effectively and a tolerance sensitivity can be reduced.

An on-axis thickness of the fifth lens L5 is defined as d9, and the camera optical lens satisfies a condition of 0.027≤d9/TTL≤0.051, which is conducive to reasonably controlling the total track lengths of the camera optical lenses.

The first prism P1 is made of glass, and the first lens L1, the second lens L2, the third lens L3, the fourth lens L4, and the fifth lens L5 are all made of plastic material. In some other embodiments, the first prism P1 and the lenses may be made of other materials, respectively.

In the present disclosure, an optical element such as an optical filter GF may be arranged between the fifth lens L5 and an image surface SI. The optical filter GF may be implemented as a glass plate or an optical filter.

In the present disclosure, an aperture S1 may be arranged between the first lens L1 and the second lens L2. The aperture S1 may also be arranged at other positions.

In the following, specific implementations will be illustrated.

In the following, embodiments will be used to describe the camera optical lens of the present disclosure. The symbols recorded in each embodiment will be described as follows. The focal length, on-axis distance, curvature radius, and on-axis thickness are all in units of mm.

TTL: total track length (the on-axis distance from the object side surface of the first prism P1 to the image surface SI) in unit of mm.

In the following, the technical solutions of the present disclosure are illustrated in detail with reference to five embodiments.

### First Embodiment

The first prism P1 has a positive refractive power, the object side surface of the first prism is convex in the paraxial region, and the image side surface of the first prism is concave in the paraxial region.

The first lens L1 has a negative refractive power, the object side surface of the first lens is convex in the paraxial region, and the image side surface of the first lens is concave in the paraxial region.

The second lens L2 has a positive refractive power, the object side surface of the second lens is convex in the paraxial region, and the image side surface of the second lens is concave in the paraxial region.

The third lens L3 with a negative refractive power, the object side surface of the third lens is concave in the paraxial region, and the image side surface of the third lens is concave in the paraxial region.

The fourth lens L4 has a positive refractive power, the object side surface of the fourth lens is convex in the paraxial region, and the image side surface of the fourth lens is concave in the paraxial region.

The fifth lens L5 has a negative refractive power, an object side surface of the fifth lens is convex in the paraxial region, and an image side surface of the fifth lens is concave in the paraxial region.

Table 1 shows design data of the camera optical lens 10 according to the first embodiment of the present disclosure.

TABLE 1
design data of the camera optical lens 10

| | R | d | | nd | | vd | |
|---|---|---|---|---|---|---|---|
| S1 | ∞ | d0= | −13.434 | | | | |
| Rp1 | 32.320 | dp1= | 8.700 | nd1 | 1.8052 | vd1 | 40.91 |
| Rp2 | 92.079 | dp2= | dp2 | | | | |
| R1 | 4.863 | d1= | 1.430 | nd2 | 1.6400 | vd2 | 23.54 |
| R2 | 2.590 | d2= | 0.389 | | | | |
| R3 | 3.594 | d3= | 2.000 | nd3 | 1.5444 | vd3 | 55.82 |
| R4 | −20.844 | d4= | 0.083 | | | | |
| R5 | −15.253 | d5= | 1.850 | nd4 | 1.6153 | vd4 | 25.94 |
| R6 | 349.703 | d6= | 1.199 | | | | |
| R7 | 6.060 | d7= | 1.000 | nd5 | 1.6701 | vd5 | 19.39 |
| R8 | 7.912 | d8= | 0.455 | | | | |
| R9 | 3.216 | d9= | 0.767 | nd6 | 1.5346 | vd6 | 55.69 |
| R10 | 2.680 | d10= | d10 | | | | |
| R11 | ∞ | d11= | 0.210 | ndg | 1.5168 | vdg | 64.17 |
| R12 | ∞ | d12= | 4.037 | | | | |

Herein, d1 is a sum of “dp1-01” and “dp1-02”, a value of “dp1-01” is 4.460 mm, and a value of “dp1-02” is 4.240 mm.

Table 2 shows the values of the relevant optical parameters of the camera optical lens 10, in the first state (infinity focus state) and the second state (macro focus state) respectively, in the First Embodiment of the present disclosure.

TABLE 2
relevant optical parameters of the camera
optical lens 10 in various focus states

| | First state | Second state |
|---|---|---|
| f | 14.383 | 14.147 |
| FOV | 27.88° | 26.42° |
| FNO | 1.98 | 1.95 |
| dp2 | 2.915 | 1.793 |
| d10 | 1.100 | 2.222 |

Herein, meanings of various symbols will be described as follows.
S1: aperture.
R: curvature radius of an optical surface, or a central curvature radius for a lens.
Rp1: curvature radius of the object side surface of the first prism P1.
Rp2: curvature radius of the image side surface of the first prism P1.
R1: curvature radius of the object side surface of the first lens L1.
R2: curvature radius of the image side surface of the first lens L1.
R3: curvature radius of the object side surface of the second lens L2.
R4: curvature radius of the image side surface of the second lens L2.
R5: curvature radius of the object side surface of the third lens L3.
R6: curvature radius of the image side surface of the third lens L3.
R7: curvature radius of the object side surface of the fourth lens L4.
R8: curvature radius of the image side surface of the fourth lens L4.
R9: curvature radius of the object side surface of the fifth lens L5.
R10: curvature radius of the image side surface of the fifth lens L5.
R11: curvature radius of an object side surface of the optical filter (GF).
R12: curvature radius of an image side surface of the optical filter (GF).
d: on-axis thickness of a lens and an on-axis distance between lenses.
d0: on-axis distance from the aperture S1 to the object side surface of the first prism P1.
dp1: a sum of an on-axis distance between the object side surface of the first prism P1 and the reflective surface and an on-axis distance between the reflective surface and the image side surface of the first prism P1.
dp1-01: on-axis distance between the object side surface of the first prism P1 and the reflective surface.
dp1-02: on-axis distance between the reflective surface and the image side surface of the first prism P1.
dp2: on-axis distance between the image side surface of the first prism P1 and the object side surface of the first lens L1.
d1: on-axis thickness of the first lens L1.
d2: on-axis distance from the image side surface of the first lens L1 to the object side surface of the second lens L2.
d3: on-axis thickness of the second lens L2.
d4: on-axis distance from the image side surface of the second lens L2 to the object side surface of the third lens L3.
d5: on-axis thickness of the third lens L3.
d6: on-axis distance from the image side surface of the third lens L3 to the object side surface of the fourth lens L4.
d7: on-axis thickness of the fourth lens L4.
d8: on-axis distance from the image side surface of the fourth lens L4 to the object side surface of the fifth lens L5.
d9: on-axis thickness of the fifth lens L5.
d10: on-axis distance from the image side surface of the fifth lens L5 to the object side surface of the optical filter (GF).
d11: on-axis thickness of the optical filter (GF).
d12: on-axis distance from the image side surface of the optical filter (GF) to the image surface SI.
nd: refractive index of a d line.
nd1: refractive index of the d line of the first prism P1.
nd2: refractive index of the d line of the first lens L1.
nd3: refractive index of the d line of the second lens L2.
nd4: refractive index of the d line of the third lens L3.
nd5: refractive index of the d line of the fourth lens L4.
nd6: refractive index of the d line of the fifth lens L5.
ndg: refractive index of the d line of the optical filter (GF).
vd: abbe number.
vd1: abbe number of the first prism P1.
vd2: abbe number of the first lens L1.
vd3: abbe number of the second lens L2.
vd4: abbe number of the third lens L3.
vd5: abbe number of the fourth lens L4.
vd6: abbe number of the fifth lens L5.
vdg: abbe number of the optical filter (GF).
FOV: field of view.
FNO: F number.

Table 3 shows aspherical surface data of each lens of the camera optical lens 10 in the First Embodiment of the present disclosure.

TABLE 3
aspherical surface data of the camera optical lens 10

| | Conic | Aspheric surface coefficients | | | |
|---|---|---|---|---|---|
| | k | A4 | A6 | A8 | A10 |
| Rp1 | −1.25482E+01 | 7.47850E−05 | −1.45400E−06 | 8.93500E−08 | 4.51040E−09 |
| Rp2 | 0.00000E+00 | 0.00000E+00 | 0.00000E+00 | 0.00000E+00 | 0.00000E+00 |
| R1 | −2.51216E+00 | −3.43440E−03 | 1.05950E−04 | −1.19900E−05 | −8.09560E−06 |
| R2 | −8.92112E−01 | −1.50260E−02 | 1.50270E−03 | −2.89610E−04 | 3.76970E−05 |
| R3 | −5.69038E+00 | 4.60790E−03 | −1.16070E−03 | 2.12990E−04 | −3.96080E−05 |
| R4 | 3.29773E+01 | −1.61880E−02 | 6.70290E−03 | −2.08630E−03 | 4.12750E−04 |
| R5 | −2.71696E+01 | −1.58120E−02 | 6.36420E−03 | −1.88350E−03 | 3.52410E−04 |
| R6 | 6.79574E+02 | −1.06950E−02 | 8.97180E−04 | 2.45990E−05 | −3.06070E−05 |
| R7 | −1.96235E−01 | −7.87820E−03 | −2.81300E−03 | 9.26210E−04 | −3.03340E−04 |
| R8 | 4.44875E+00 | −1.73450E−02 | 1.17210E−03 | −4.14170E−04 | 1.93130E−04 |
| R9 | −5.55646E+00 | −4.00270E−02 | 3.36880E−03 | 8.84350E−05 | 1.41340E−04 |
| R10 | −7.13840E−01 | −5.30800E−02 | 8.15600E−03 | −7.54120E−04 | −5.19840E−05 |

| | |
|---|---|
| Conic | Aspheric surface coefficients |

| | k | A12 | A14 | A16 | A18 |
|---|---|---|---|---|---|
| Rp1 | −1.25482E+01 | −7.58200E−10 | −2.32190E−11 | 7.72010E−12 | −4.23560E−13 |
| Rp2 | 0.00000E+00 | 0.00000E+00 | 0.00000E+00 | 0.00000E+00 | 0.00000E+00 |
| R1 | −2.51216E+00 | 2.83300E−06 | −4.90830E−07 | 4.78310E−08 | −2.47450E−09 |
| R2 | −8.92112E−01 | −2.48850E−06 | −4.04590E−08 | 2.46900E−08 | −1.98370E−09 |
| R3 | −5.69038E+00 | 6.60200E−06 | −7.35840E−07 | 5.28900E−08 | −2.39400E−09 |
| R4 | 3.29773E+01 | −5.01910E−05 | 3.65160E−06 | −1.47290E−07 | 2.61180E−09 |
| R5 | −2.71696E+01 | −3.98750E−05 | 2.50450E−06 | −6.44810E−08 | −8.39730E−10 |
| R6 | 6.79574E+02 | 7.22130E−06 | −9.95700E−07 | 8.77630E−08 | −4.54950E−09 |
| R7 | −1.96235E−01 | 9.17010E−05 | −2.04470E−05 | 2.94960E−06 | −2.40380E−07 |
| R8 | 4.44875E+00 | −6.04560E−05 | 1.11850E−05 | −1.13920E−06 | 5.43560E−08 |
| R9 | −5.55646E+00 | −1.16070E−04 | 3.12000E−05 | −4.16130E−06 | 2.77000E−07 |
| R10 | −7.13840E−01 | 2.91330E−05 | −4.49850E−06 | 3.65040E−07 | −1.55610E−08 |

| | | Aspheric surface |
|---|---|---|
| | Conic | coefficients |
| | k | A20 |
| Rp1 | −1.25482E+01 | 7.56760E−15 |
| Rp2 | 0.00000E+00 | 0.00000E+00 |
| R1 | −2.51216E+00 | 5.25050E−11 |
| R2 | −8.92112E−01 | 5.27950E−11 |
| R3 | −5.69038E+00 | 5.02270E−11 |
| R4 | 3.29773E+01 | −1.49930E−12 |
| R5 | −2.71696E+01 | 6.21270E−11 |
| R6 | 6.79574E+02 | 1.03590E−10 |
| R7 | −1.96235E−01 | 8.23770E−09 |
| R8 | 4.44875E+00 | −7.51770E−10 |
| R9 | −5.55646E+00 | −7.25080E−09 |
| R10 | −7.13840E−01 | 2.75050E−10 |

For convenience, an aspheric surface of each lens surface uses the aspheric surfaces as expressed in the following condition (1). However, the present disclosure is not limited to the aspherical polynomials form as expressed in the condition (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} \qquad ( 1 )$$

Herein, K is a conic coefficient, A4, A6, A8, A10, A12, A14, A16, A18, and A20 are aspheric surface coefficients, c is a central curvature of an optical surface, r is a vertical distance between a point on an aspheric curve and the optical axis, and z is a depth of the aspheric surface (the vertical distance between a point on the aspheric surface from which a vertical distance to the optical axis is r and a tangent plane tangent to a vertex on the optical axis of the aspheric surface).

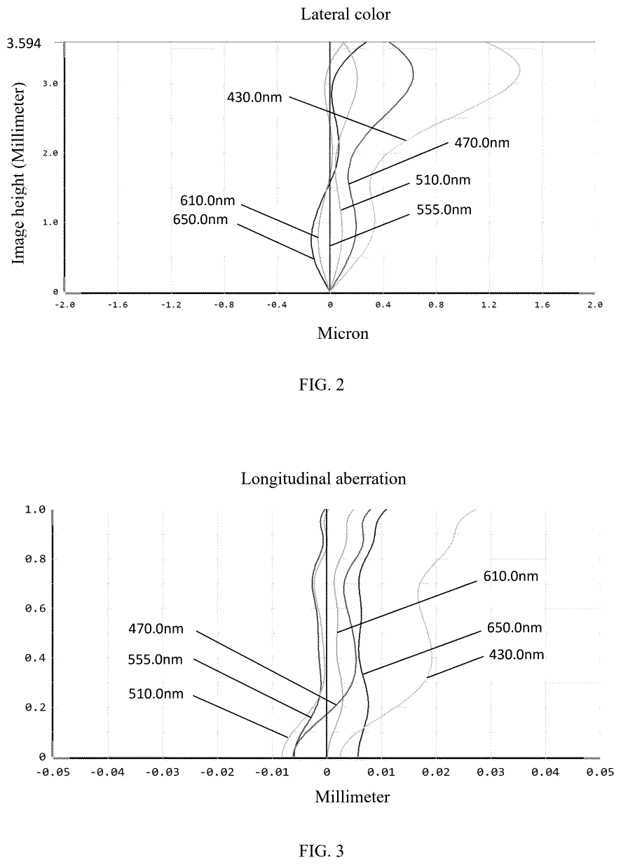

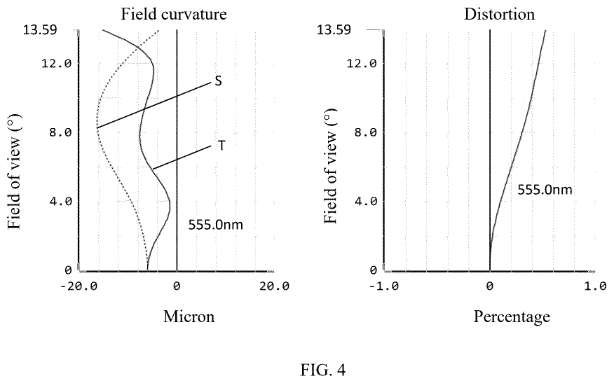

FIG. 2 and FIG. 3 illustrate a lateral color and a longitudinal aberration of the camera optical lens 10 according to the First Embodiment after light with wavelengths of 650.0 nm, 610.0 nm, 555.0 nm, 510.0 nm, 470.0 nm, and 430.0 nm passing through the camera optical lens 10, respectively. FIG. 4 schematically illustrates a field curvature and a distortion of the camera optical lens 10 after light with a wavelength of 555.0 nm passing through the camera optical lens 10 according to the First Embodiment. A field curvature S in FIG. 4 is a field curvature in a sagittal direction, and Tis a field curvature in a tangential direction.

Table 16 in the following lists various values in the First Embodiment, Second Embodiment, Third Embodiment, Fourth Embodiment, and Fifth Embodiment corresponding to parameters in the above conditions.

It can be derived, according to Table 16, that the First Embodiment satisfies the conditions.

In the embodiment, an entrance pupil diameter (ENPD) of the camera optical lens 10 in the first state is 7.252 mm, an image height IH of 1.0H is 3.594 mm, and a diagonal field of view FOV is 27.88°. Thus, the camera optical lens 10 can meet the requirements of long focal lengths, high magnification, and miniaturization while having excellent optical characteristics.

### Second Embodiment

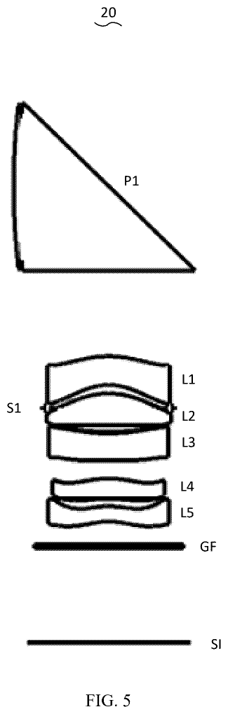

The symbols in the Second Embodiment have the same meanings as those in the First Embodiment. The structure of the camera optical lens 20 according to the Second Embodiment is shown in FIG. 5, and the camera optical lens 20 is in the first state. In the following, only the differences are illustrated.

The Second Embodiment differs from the First Embodiment in that in the Second Embodiment, the image side surface of the first prism P1 is planar in the paraxial region, and the fifth lens L5 has a positive refractive power.

Table 4 shows design data of the camera optical lens 20 according to the Second Embodiment of the present disclosure.

TABLE 4
design data of the camera optical lens 20

| | R | d | | nd | | vd | |
|---|---|---|---|---|---|---|---|
| S1 | ∞ | d0= | −14.732 | | | | |
| Rp1 | 37.490 | dp1= | 8.700 | nd1 | 1.8052 | vd1 | 40.91 |
| Rp2 | ∞ | dp2= | dp2 | | | | |
| R1 | 4.876 | d1= | 1.405 | nd2 | 1.6400 | vd2 | 23.54 |
| R2 | 2.482 | d2= | 0.415 | | | | |
| R3 | 3.288 | d3= | 1.871 | nd3 | 1.5444 | vd3 | 55.82 |
| R4 | −28.338 | d4= | 0.103 | | | | |
| R5 | −9.842 | d5= | 1.322 | nd4 | 1.6153 | vd4 | 25.94 |
| R6 | 38.146 | d6= | 0.897 | | | | |
| R7 | 4.489 | d7= | 1.000 | nd5 | 1.6701 | vd5 | 19.39 |
| R8 | 6.394 | d8= | 0.363 | | | | |
| R9 | 3.143 | d9= | 0.751 | nd6 | 1.5346 | vd6 | 55.69 |
| R10 | 2.941 | d10= | d10 | | | | |
| R11 | ∞ | d11= | 0.210 | ndg | 1.5168 | vdg | 64.17 |
| R12 | ∞ | d12= | 4.644 | | | | |

Herein, d1 is a sum of “dp1-01” and “dp1-02”, a value of “dp1-01” is 4.550 mm, and a value of “dp1-02” is 4.150 mm.

Table 5 shows the values of the relevant optical parameters of the camera optical lens 20, in the first state (infinity focus state) and the second state (macro focus state) respectively, in the Second Embodiment of the present disclosure.

TABLE 5
relevant optical parameters of the camera
optical lens 20 in various focus states

| | First state | Second state |
|---|---|---|
| f | 14.370 | 14.083 |
| FOV | 27.86° | 26.71° |
| FNO | 1.98 | 1.94 |
| dp2 | 4.212 | 3.079 |
| d10 | 1.100 | 2.233 |

Table 6 shows aspherical surface data of each lens of the camera optical lens 20 in the Second Embodiment of the present disclosure.

TABLE 6
aspherical surface data of the camera optical lens 20

| | Conic | Aspheric surface coefficients | | | |
|---|---|---|---|---|---|
| | k | A4 | A6 | A8 | A10 |
| Rp1 | −4.64385E+01 | 1.14500E−04 | −9.80070E−07 | −2.15720E−07 | 3.47650E−08 |
| Rp2 | 0.00000E+00 | 0.00000E+00 | 0.00000E+00 | 0.00000E+00 | 0.00000E+00 |
| R1 | −2.35354E+00 | −3.79320E−03 | 5.06590E−05 | −8.24180E−06 | −8.75730E−06 |
| R2 | −9.16656E−01 | −1.53290E−02 | 1.52270E−03 | −2.97110E−04 | 3.76890E−05 |
| R3 | −5.00184E+00 | 5.04270E−03 | −1.17870E−03 | 2.14920E−04 | −3.93960E−05 |
| R4 | 1.46876E+01 | −1.63190E−02 | 6.74940E−03 | −2.07290E−03 | 4.10980E−04 |
| R5 | −1.46329E+01 | −1.26130E−02 | 6.49720E−03 | −1.89340E−03 | 3.53880E−04 |
| R6 | −9.12983E+01 | −1.30030E−02 | 1.49690E−03 | 2.56370E−05 | −3.61270E−05 |
| R7 | −6.55852E−01 | −1.00190E−02 | −3.31230E−03 | 1.07270E−03 | −3.17010E−04 |
| R8 | 3.27814E+00 | −2.20390E−02 | 1.34720E−03 | −4.05850E−04 | 1.89820E−04 |
| R9 | −5.64004E+00 | −4.32680E−02 | 4.21590E−03 | −2.93460E−05 | 1.48900E−04 |
| R10 | −6.49689E−01 | −4.95950E−02 | 7.58950E−03 | −6.75530E−04 | −5.76760E−05 |

| | |
|---|---|
| Conic | Aspheric surface coefficients |

| | k | A12 | A14 | A16 | A18 |
|---|---|---|---|---|---|
| Rp1 | −4.64385E+01 | −2.02960E−09 | −1.83390E−11 | 8.75050E−12 | −4.31520E−13 |
| Rp2 | 0.00000E+00 | 0.00000E+00 | 0.00000E+00 | 0.00000E+00 | 0.00000E+00 |
| R1 | −2.35354E+00 | 2.78990E−06 | −4.82690E−07 | 4.73730E−08 | −2.47420E−09 |
| R2 | −9.16656E−01 | −2.49280E−06 | −4.29590E−08 | 2.47870E−08 | −1.98510E−09 |
| R3 | −5.00184E+00 | 6.61910E−06 | −7.37860E−07 | 5.28110E−08 | −2.38930E−09 |
| R4 | 1.46876E+01 | −5.02380E−05 | 3.66630E−06 | −1.48160E−07 | 2.61690E−09 |
| R5 | −1.46329E+01 | −4.00070E−05 | 2.47670E−06 | −6.19510E−08 | −8.41260E−10 |
| R6 | −9.12983E+01 | 7.46310E−06 | −9.44740E−07 | 8.44830E−08 | −4.53200E−09 |
| R7 | −6.55852E−01 | 9.22350E−05 | −2.04550E−05 | 2.94740E−06 | −2.40470E−07 |
| R8 | 3.27814E+00 | −6.03950E−05 | 1.11840E−05 | −1.13910E−06 | 5.44130E−08 |
| R9 | −5.64004E+00 | −1.16030E−04 | 3.12000E−05 | −4.16040E−06 | 2.77120E−07 |
| R10 | −6.49689E−01 | 2.93600E−05 | −4.50350E−06 | 3.64980E−07 | −1.55090E−08 |

| | | Aspheric surface |
|---|---|---|
| | Conic | coefficients |
| | k | A20 |
| Rp1 | −4.64385E+01 | 7.08840E−15 |
| Rp2 | 0.00000E+00 | 0.00000E+00 |
| R1 | −2.35354E+00 | 5.28590E−11 |
| R2 | −9.16656E−01 | 5.40480E−11 |
| R3 | −5.00184E+00 | 5.04620E−11 |
| R4 | 1.46876E+01 | −6.81960E−13 |
| R5 | −1.46329E+01 | 6.22170E−11 |
| R6 | −9.12983E+01 | 1.02520E−10 |
| R7 | −6.55852E−01 | 8.27850E−09 |
| R8 | 3.27814E+00 | −7.43140E−10 |
| R9 | −5.64004E+00 | −7.25280E−09 |
| R10 | −6.49689E−01 | 2.72830E−10 |

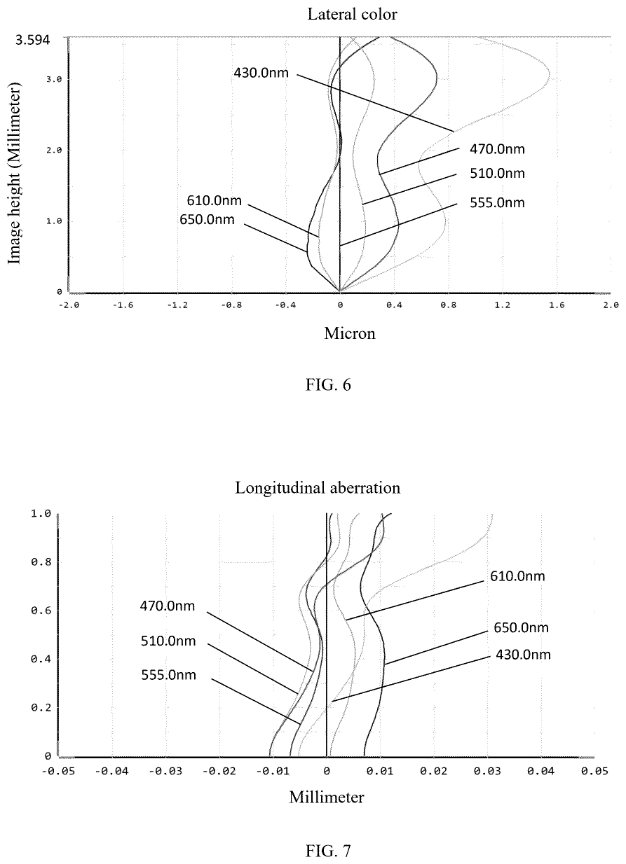

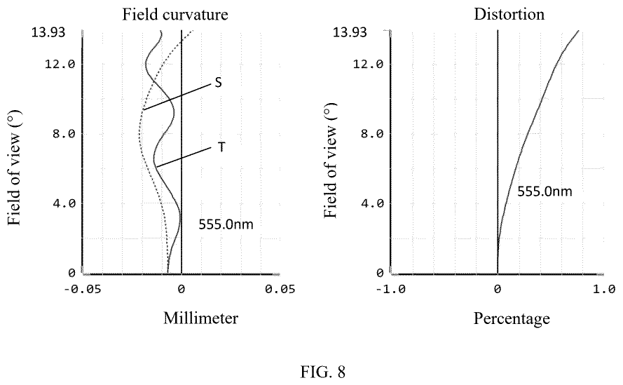

FIG. 6 and FIG. 7 illustrate a lateral color and a longitudinal aberration of the camera optical lens 20 according to the Second Embodiment after light with wavelengths of 650.0 nm, 610.0 nm, 555.0 nm, 510.0 nm, 470.0 nm, and 430.0 nm passing through the camera optical lens 20, respectively. FIG. 8 schematically illustrates a field curvature and a distortion of the camera optical lens 20 after light with a wavelength of 555.0 nm passing through the camera optical lens 20 according to the Second Embodiment. A field curvature S in FIG. 8 is a field curvature in a sagittal direction, and Tis a field curvature in a tangential direction.

It can be derived, according to Table 16, that the Second Embodiment satisfies the conditions.

In the embodiment, an entrance pupil diameter (ENPD) of the camera optical lens 20 in the first state is 7.245 mm, an image height IH of 1.0H is 3.594 mm, and a diagonal field of view FOV is 27.86°. Thus, the camera optical lens 20 can meet the requirements of long focal lengths, high magnification, and miniaturization while having excellent optical characteristics.

### Third Embodiment

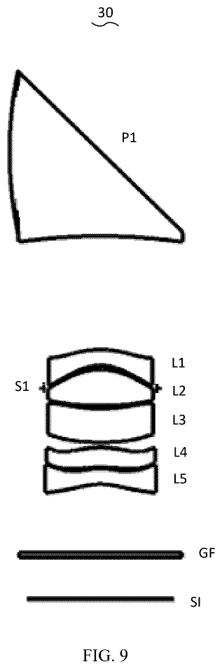

The symbols in the Third Embodiment have the same meanings as those in the First Embodiment. The structure of the camera optical lens 30 according to the Third Embodiment is shown in FIG. 9, and the camera optical lens 30 is in the first state. In the following, only the differences are illustrated.

The Third Embodiment differs from the First Embodiment in that in the Third Embodiment, the image side surface of the third lens L3 is convex in the paraxial region, and the fifth lens L5 has a positive refractive power.

Table 7 shows design data of the camera optical lens 30 according to the Third Embodiment of the present disclosure.

TABLE 7
design data of the camera optical lens 30

| | R | d | | nd | | vd | |
|---|---|---|---|---|---|---|---|
| S1 | ∞ | d0= | −15.411 | | | | |
| Rp1 | 19.790 | dp1= | 8.700 | nd1 | 1.8052 | vd1 | 40.91 |
| Rp2 | 28.271 | dp2= | dp2 | | | | |
| R1 | 4.144 | d1= | 0.800 | nd2 | 1.6400 | vd2 | 23.54 |
| R2 | 2.161 | d2= | 0.195 | | | | |
| R3 | 2.762 | d3= | 1.815 | nd3 | 1.5444 | vd3 | 55.82 |
| R4 | −128.976 | d4= | 0.176 | | | | |
| R5 | −6.350 | d5= | 1.684 | nd4 | 1.6153 | vd4 | 25.94 |
| R6 | −23.562 | d6= | 0.268 | | | | |
| R7 | 4.339 | d7= | 1.000 | nd5 | 1.6701 | vd5 | 19.39 |
| R8 | 6.639 | d8= | 0.049 | | | | |
| R9 | 3.010 | d9= | 0.790 | nd6 | 1.5346 | vd6 | 55.69 |
| R10 | 2.736 | d10= | d10 | | | | |
| R11 | ∞ | d11= | 0.210 | ndg | 1.5168 | vdg | 64.17 |
| R12 | ∞ | d12= | 2.129 | | | | |

Herein, d1 is a sum of “dp1-01” and “dp1-02”, a value of “dp1-01” is 4.475 mm, and a value of “dp1-02” is 4.225 mm.

Table 8 shows the values of the relevant optical parameters of the camera optical lens 30, in the first state (infinity focus state) and the second state (macro focus state) respectively, in the Third Embodiment of the present disclosure.

TABLE 8
relevant optical parameters of the camera
optical lens 30 in various focus states

| | First state | Second state |
|---|---|---|
| f | 14.376 | 14.093 |
| FOV | 27.88° | 27.88° |
| FNO | 1.98 | 1.94 |
| dp2 | 5.716 | 4.638 |
| d10 | 3.468 | 4.546 |

Table 9 shows aspherical surface data of each lens of the camera optical lens 30 in the Third Embodiment of the present disclosure.

TABLE 9
aspherical surface data of the camera optical lens 30

| | Conic | Aspheric surface coefficients | | | |
|---|---|---|---|---|---|
| | k | A4 | A6 | A8 | A10 |
| Rp1 | −1.22976E+01 | 1.90790E−04 | −1.70620E−06 | −2.57560E−07 | 4.05110E−08 |
| Rp2 | 0.00000E+00 | 0.00000E+00 | 0.00000E+00 | 0.00000E+00 | 0.00000E+00 |
| R1 | −2.54521E+00 | −4.71980E−03 | −1.20300E−04 | −2.00350E−06 | −8.34990E−06 |
| R2 | −9.35277E−01 | −1.56000E−02 | 1.56710E−03 | −3.02090E−04 | 3.69000E−05 |
| R3 | −4.13602E+00 | 7.86810E−03 | −1.18750E−03 | 2.01120E−04 | −4.05940E−05 |
| R4 | 9.90000E+01 | −1.81570E−02 | 6.87470E−03 | −2.06720E−03 | 4.09950E−04 |
| R5 | −2.55256E+01 | −1.11430E−02 | 6.32810E−03 | −1.89130E−03 | 3.56580E−04 |
| R6 | 6.59944E+01 | −1.39030E−02 | 1.69540E−03 | 2.27030E−05 | −3.65380E−05 |
| R7 | −1.05122E+00 | −1.05850E−02 | −3.44560E−03 | 1.07720E−03 | −3.20870E−04 |
| R8 | 4.04328E+00 | −2.15200E−02 | 8.59550E−04 | −3.86850E−04 | 1.90900E−04 |
| R9 | −6.99079E+00 | −4.33780E−02 | 4.81940E−03 | −5.44570E−05 | 1.48890E−04 |
| R10 | −3.99698E−01 | −4.78600E−02 | 7.29790E−03 | −6.24750E−04 | −6.44900E−05 |

| | |
|---|---|
| Conic | Aspheric surface coefficients |

| | k | A12 | A14 | A16 | A18 |
|---|---|---|---|---|---|
| Rp1 | −1.22976E+01 | −2.12170E−09 | −3.97100E−11 | 9.29900E−12 | −3.79420E−13 |
| Rp2 | 0.00000E+00 | 0.00000E+00 | 0.00000E+00 | 0.00000E+00 | 0.00000E+00 |
| R1 | −2.54521E+00 | 2.74440E−06 | −4.82200E−07 | 4.54670E−08 | −2.47420E−09 |
| R2 | −9.35277E−01 | −2.49690E−06 | −4.01470E−08 | 2.48100E−08 | −1.98510E−09 |
| R3 | −4.13602E+00 | 6.54610E−06 | −7.37890E−07 | 5.14520E−08 | −2.38930E−09 |
| R4 | 9.90000E+01 | −5.02710E−05 | 3.66700E−06 | −1.49270E−07 | 2.61690E−09 |
| R5 | −2.55256E+01 | −3.97790E−05 | 2.48230E−06 | −6.40080E−08 | −8.41260E−10 |
| R6 | 6.59944E+01 | 7.60510E−06 | −9.11650E−07 | 8.72240E−08 | −4.53200E−09 |
| R7 | −1.05122E+00 | 9.23840E−05 | −2.04550E−05 | 2.94740E−06 | −2.40470E−07 |
| R8 | 4.04328E+00 | −6.03890E−05 | 1.11840E−05 | −1.13910E−06 | 5.44130E−08 |
| R9 | −6.99079E+00 | −1.15690E−04 | 3.12000E−05 | −4.16040E−06 | 2.77120E−07 |
| R10 | −3.99698E−01 | 2.95590E−05 | −4.50350E−06 | 3.64980E−07 | −1.55090E−08 |

| | | Aspheric surface |
|---|---|---|
| | Conic | coefficients |
| | k | A20 |
| Rp1 | −1.22976E+01 | 5.19000E−15 |
| Rp2 | 0.00000E+00 | 0.00000E+00 |
| R1 | −2.54521E+00 | 5.28590E−11 |
| R2 | −9.35277E−01 | 5.40480E−11 |
| R3 | −4.13602E+00 | 5.04620E−11 |
| R4 | 9.90000E+01 | −6.81960E−13 |
| R5 | −2.55256E+01 | 6.22170E−11 |
| R6 | 6.59944E+01 | 1.02520E−10 |
| R7 | −1.05122E+00 | 8.27850E−09 |
| R8 | 4.04328E+00 | −7.43140E−10 |
| R9 | −6.99079E+00 | −7.25280E−09 |
| R10 | −3.99698E−01 | 2.72830E−10 |

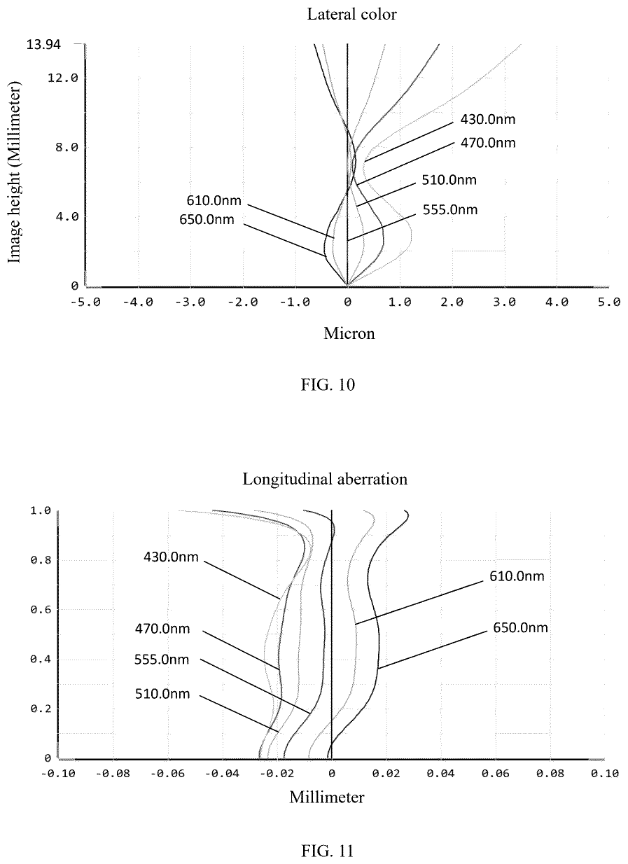

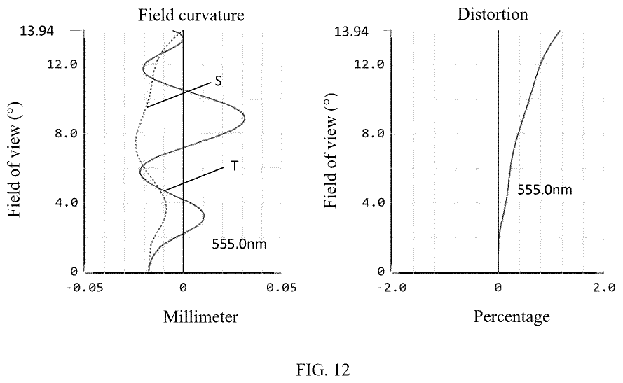

FIG. 10 and FIG. 11 illustrate a lateral color and a longitudinal aberration of the camera optical lens 30 according to the Third Embodiment after light with wavelengths of 650.0 nm, 610.0 nm, 555.0 nm, 510.0 nm, 470.0 nm, and 430.0 nm passing through the camera optical lens 30, respectively. FIG. 12 schematically illustrates a field curvature and a distortion of the camera optical lens 30 after light with a wavelength of 555.0 nm passing through the camera optical lens 30 according to the Third Embodiment. A field curvature S in FIG. 12 is a field curvature in a sagittal direction, and Tis a field curvature in a tangential direction.

It can be derived, according to Table 16, that the Third Embodiment satisfies the conditions.

In the embodiment, an entrance pupil diameter (ENPD) of the camera optical lens 30 in the first state is 7.249 mm, an image height IH of 1.0H is 3.594 mm, and a diagonal field of view FOV is 27.88°. Thus, the camera optical lens 30 can meet the requirements of long focal lengths, high magnification, and miniaturization while having excellent optical characteristics.

### Fourth Embodiment

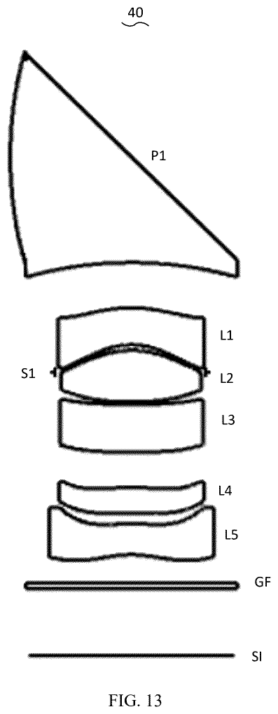

The symbols in the Fourth Embodiment have the same meanings as those in the First Embodiment. The structure of the camera optical lens 40 according to the Fourth Embodiment is shown in FIG. 13, and the camera optical lens 40 is in the first state. In the following, only the differences are illustrated.

The Fourth Embodiment differs from the First Embodiment in that in the Fourth Embodiment, the object side surface of the third lens L3 is convex in the paraxial region.

Table 10 shows design data of the camera optical lens 40 according to the Fourth Embodiment of the present disclosure.

TABLE 10
design data of the camera optical lens 40

| | R | d | | nd | | vd | |
|---|---|---|---|---|---|---|---|
| S1 | ∞ | d0= | −12.109 | | | | |
| Rp1 | 15.813 | dp1= | 8.700 | nd1 | 1.8052 | vd1 | 40.91 |
| Rp2 | 14.376 | dp2= | dp2 | | | | |
| R1 | 5.042 | d1= | 1.433 | nd2 | 1.6400 | vd2 | 23.54 |
| R2 | 2.413 | d2= | 0.219 | | | | |
| R3 | 3.172 | d3= | 2.000 | nd3 | 1.5444 | vd3 | 55.82 |
| R4 | −16.641 | d4= | 0.095 | | | | |
| R5 | 263.972 | d5= | 1.850 | nd4 | 1.6153 | vd4 | 25.94 |
| R6 | 88.896 | d6= | 1.384 | | | | |
| R7 | 10.028 | d7= | 1.000 | nd5 | 1.6700 | vd5 | 19.39 |
| R8 | 29.626 | d8= | 0.409 | | | | |
| R9 | 7.463 | d9= | 1.201 | nd6 | 1.5346 | vd6 | 55.69 |
| R10 | 3.733 | d10= | d10 | | | | |
| R11 | ∞ | d11= | 0.210 | ndg | 1.5168 | vdg | 64.17 |
| R12 | ∞ | d12= | −12.109 | | | | |

Herein, d1 is a sum of “dp1-01” and “dp1-02”, a value of “dp1-01” is 4.550 mm, and a value of “dp1-02” is 4.150 mm.

Table 11 shows the values of the relevant optical parameters of the camera optical lens 40, in the first state (infinity focus state) and the second state (macro focus state) respectively, in the Fourth Embodiment of the present disclosure.

TABLE 5
relevant optical parameters of the camera
optical lens 40 in various focus states

| | First state | Second state |
|---|---|---|
| f | 14.376 | 14.217 |
| FOV | 27.88° | 27.88° |
| FNO | 1.98 | 1.96 |
| dp2 | 1.757 | 0.638 |
| d10 | 1.098 | 2.217 |

Table 12 shows aspherical surface data of each lens of the camera optical lens 40 in the Fourth Embodiment of the present disclosure.

TABLE 12
aspherical surface data of the camera optical lens 40

| | Conic | Aspheric surface coefficients | | | |
|---|---|---|---|---|---|
| | k | A4 | A6 | A8 | A10 |
| Rp1 | −2.80178E+00 | 1.32480E−04 | −4.62140E−07 | 2.84850E−08 | 7.57240E−09 |
| Rp2 | 0.00000E+00 | 0.00000E+00 | 0.00000E+00 | 0.00000E+00 | 0.00000E+00 |
| R1 | −2.92263E+00 | −4.00330E−03 | 3.18050E−05 | −1.21380E−05 | −8.32720E−06 |
| R2 | −9.20691E−01 | −1.53670E−02 | 1.55610E−03 | −2.88680E−04 | 3.71370E−05 |
| R3 | −4.50615E+00 | 5.46300E−03 | −1.18880E−03 | 2.08600E−04 | −3.94970E−05 |
| R4 | 2.68291E+01 | −1.62530E−02 | 6.69670E−03 | −2.08520E−03 | 4.13070E−04 |
| R5 | −9.99000E+02 | −1.62240E−02 | 6.39410E−03 | −1.88020E−03 | 3.52750E−04 |
| R6 | 6.38186E+02 | −1.08780E−02 | 8.82690E−04 | 2.52550E−05 | −3.07650E−05 |
| R7 | −4.34271E+00 | −8.65180E−03 | −2.48030E−03 | 8.92240E−04 | −3.03250E−04 |
| R8 | 2.58614E+01 | −1.44050E−02 | 1.09380E−03 | −4.11220E−04 | 1.93250E−04 |
| R9 | −5.13569E+00 | −3.93260E−02 | 7.18970E−03 | −2.10280E−03 | 8.15640E−04 |
| R10 | −3.35380E−01 | −3.49370E−02 | 6.14550E−03 | −1.17510E−03 | 1.92620E−04 |

| | |
|---|---|
| Conic | Aspheric surface coefficients |

| | k | A12 | A14 | A16 | A18 |
|---|---|---|---|---|---|
| Rp1 | −2.80178E+00 | −7.53370E−10 | −2.55310E−11 | 7.47140E−12 | −4.04680E−13 |
| Rp2 | 0.00000E+00 | 0.00000E+00 | 0.00000E+00 | 0.00000E+00 | 0.00000E+00 |
| R1 | −2.92263E+00 | 2.77870E−06 | −4.94640E−07 | 4.86020E−08 | −2.47180E−09 |
| R2 | −9.20691E−01 | −2.53850E−06 | −4.04080E−08 | 2.46070E−08 | −2.00170E−09 |
| R3 | −4.50615E+00 | 6.63590E−06 | −7.34760E−07 | 5.28690E−08 | −2.40500E−09 |
| R4 | 2.68291E+01 | −5.01130E−05 | 3.66310E−06 | −1.46550E−07 | 2.60810E−09 |
| R5 | −9.99000E+02 | −3.98690E−05 | 2.50220E−06 | −6.47860E−08 | −8.21960E−10 |
| R6 | 6.38186E+02 | 7.26380E−06 | −9.86940E−07 | 8.67890E−08 | −4.61050E−09 |
| R7 | −4.34271E+00 | 9.21010E−05 | −2.04120E−05 | 2.94980E−06 | −2.41130E−07 |
| R8 | 2.58614E+01 | −6.04400E−05 | 1.12210E−05 | −1.14150E−06 | 5.42640E−08 |
| R9 | −5.13569E+00 | −2.60410E−04 | 5.35080E−05 | −6.52250E−06 | 4.26880E−07 |
| R10 | −3.35380E−01 | −2.57900E−05 | 2.63580E−06 | −1.85040E−07 | 7.62930E−09 |

| | | Aspheric surface |
|---|---|---|
| | Conic | coefficients |
| | k | A20 |
| Rp1 | −2.80178E+00 | 7.22490E−15 |
| Rp2 | 0.00000E+00 | 0.00000E+00 |
| R1 | −2.92263E+00 | 4.75930E−11 |
| R2 | −9.20691E−01 | 4.55500E−11 |
| R3 | −4.50615E+00 | 5.35590E−11 |
| R4 | 2.68291E+01 | −5.08180E−13 |
| R5 | −9.99000E+02 | 6.30950E−11 |
| R6 | 6.38186E+02 | 1.06450E−10 |
| R7 | −4.34271E+00 | 8.18770E−09 |
| R8 | 2.58614E+01 | −7.44300E−10 |
| R9 | −5.13569E+00 | −1.14180E−08 |
| R10 | −3.35380E−01 | −1.33560E−10 |

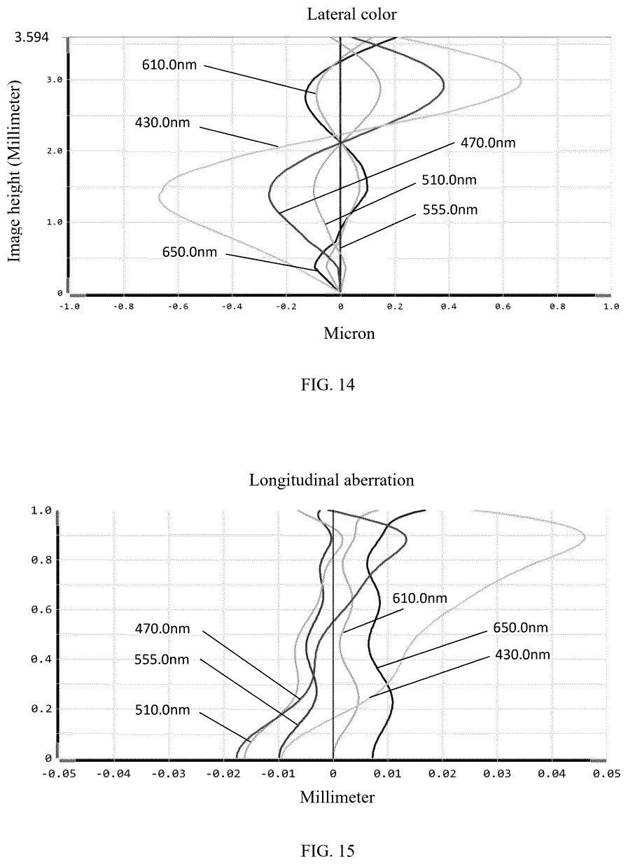

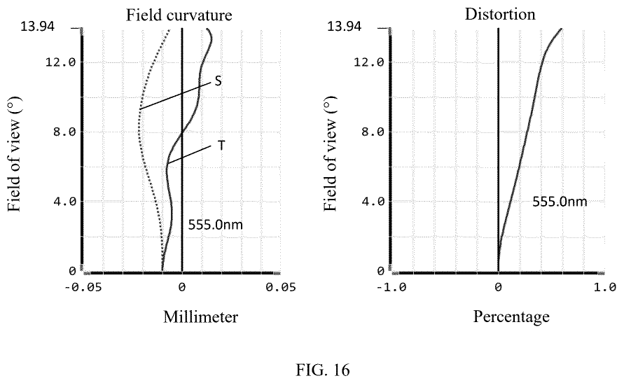

FIG. 14 and FIG. 15 illustrate a lateral color and a longitudinal aberration of the camera optical lens 40 according to the Fourth Embodiment after light with wavelengths of 650.0 nm, 610.0 nm, 555.0 nm, 510.0 nm, 470.0 nm, and 430.0 nm passing through the camera optical lens 40, respectively. FIG. 16 schematically illustrates a field curvature and a distortion of the camera optical lens 40 after light with a wavelength of 555.0 nm passing through the camera optical lens 40 according to the Fourth Embodiment. A field curvature S in FIG. 16 is a field curvature in a sagittal direction, and Tis a field curvature in a tangential direction.

It can be derived, according to Table 16, that the Fourth Embodiment satisfies the conditions.

In the embodiment, an entrance pupil diameter (ENPD) of the camera optical lens 40 in the first state is 7.249 mm, an image height IH of 1.0H is 3.594 mm, and a diagonal field of view FOV is 27.88°. Thus, the camera optical lens 40 can meet the requirements of long focal lengths, high magnification, and miniaturization while having excellent optical characteristics.

### Fifth Embodiment

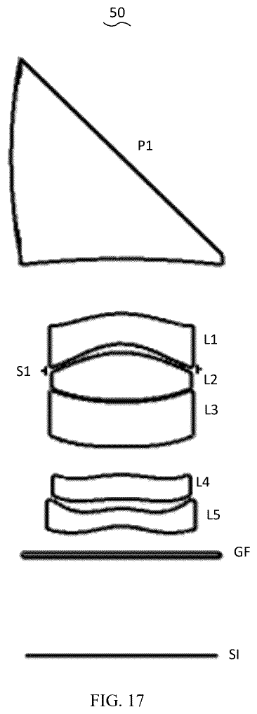

The symbols in the Fifth Embodiment have the same meanings as those in the First Embodiment. The structure of the camera optical lens 50 according to the Fifth Embodiment is shown in FIG. 17, and the camera optical lens 50 is in the first state. In the following, only the differences are illustrated.

The Fifth Embodiment differs from the First Embodiment in that in the Fifth Embodiment, the image side surface of the third lens L3 is convex in the paraxial region.

Table 13 shows design data of the camera optical lens 50 according to the Fifth Embodiment of the present disclosure.

TABLE 13
design data of the camera optical lens 50

| | R | d | | nd | | vd | |
|---|---|---|---|---|---|---|---|
| S1 | ∞ | d0= | −12.607 | | | | |
| Rp1 | 23.416 | dp1= | 8.700 | nd1 | 1.8052 | vd1 | 40.91 |
| Rp2 | 33.453 | dp2= | dp2 | | | | |
| R1 | 4.453 | d1= | 1.261 | nd2 | 1.6400 | vd2 | 23.54 |
| R2 | 2.461 | d2= | 0.364 | | | | |
| R3 | 3.574 | d3= | 1.985 | nd3 | 1.5444 | vd3 | 55.82 |
| R4 | −20.074 | d4= | 0.074 | | | | |
| R5 | −12.940 | d5= | 1.850 | nd4 | 1.6153 | vd4 | 25.94 |
| R6 | −71.861 | d6= | 1.180 | | | | |
| R7 | 5.581 | d7= | 1.000 | nd5 | 1.6700 | vd5 | 19.39 |
| R8 | 6.725 | d8= | 0.411 | | | | |
| R9 | 3.013 | d9= | 0.736 | nd6 | 1.5346 | vd6 | 55.69 |
| R10 | 2.636 | d10= | d10 | | | | |
| R11 | ∞ | d11= | 0.210 | ndg | 1.5168 | vdg | 64.17 |
| R12 | ∞ | d12= | 4.091 | | | | |

Herein, d1 is a sum of “dp1-01” and “dp1-02”, a value of “dp1-01” is 4.465 mm, and a value of “dp1-02” is 4.235 mm.

Table 14 shows the values of the relevant optical parameters of the camera optical lens 50, in the first state (infinity focus state) and the second state (macro focus state) respectively, in the Fifth Embodiment of the present disclosure.

TABLE 14
relevant optical parameters of the camera
optical lens 50 in various focus states

| | First state | Second state |
|---|---|---|
| f | 14.383 | 14.164 |
| FOV | 27.90° | 27.90° |
| FNO | 1.98 | 1.95 |
| dp2 | 2.282 | 1.170 |
| d10 | 1.100 | 2.212 |

Table 15 shows aspherical surface data of each lens of the camera optical lens 50 in the Fifth Embodiment of the present disclosure.

TABLE 15
aspherical surface data of the camera optical lens 50

| | Conic | Aspheric surface coefficients | | | |
|---|---|---|---|---|---|
| | k | A4 | A6 | A8 | A10 |
| Rp1 | −6.06571E+00 | 9.27800E−05 | −1.24550E−06 | 6.41650E−08 | 7.73870E−09 |
| Rp2 | 0.00000E+00 | 0.00000E+00 | 0.00000E+00 | 0.00000E+00 | 0.00000E+00 |
| RI | −2.46309E+00 | −3.61440E−03 | 6.71580E−05 | −1.26380E−05 | −8.25520E−06 |
| R2 | −9.10649E−01 | −1.52070E−02 | 1.50220E−03 | −2.90900E−04 | 3.76180E−05 |
| R3 | −5.64462E+00 | 4.52010E−03 | −1.16720E−03 | 2.14380E−04 | −3.93520E−05 |
| R4 | 3.31910E+01 | −1.62420E−02 | 6.69990E−03 | −2.08520E−03 | 4.12760E−04 |
| R5 | −2.92582E+01 | −1.55640E−02 | 6.37550E−03 | −1.88520E−03 | 3.52270E−04 |
| R6 | −7.42951E+01 | −1.08000E−02 | 9.05660E−04 | 2.51040E−05 | −3.07400E−05 |
| R7 | −1.72761E−01 | −7.69640E−03 | −2.96270E−03 | 9.46320E−04 | −3.03200E−04 |
| R8 | 3.79838E+00 | −1.79770E−02 | 1.07020E−03 | −4.19680E−04 | 1.94740E−04 |
| R9 | −5.09801E+00 | −4.02660E−02 | 3.42650E−03 | 7.85180E−05 | 1.42550E−04 |
| R10 | −7.81895E−01 | −5.37110E−02 | 8.25260E−03 | −7.46650E−04 | −5.38870E−05 |

| | |
|---|---|
| Conic | Aspheric surface coefficients |

| | k | A12 | A14 | A16 | A18 |
|---|---|---|---|---|---|
| Rp1 | −6.06571E+00 | −8.34930E−10 | −2.76470E−11 | 7.55700E−12 | −3.96950E−13 |
| Rp2 | 0.00000E+00 | 0.00000E+00 | 0.00000E+00 | 0.00000E+00 | 0.00000E+00 |
| R1 | −2.46309E+00 | 2.81920E−06 | −4.90720E−07 | 4.79890E−08 | −2.46470E−09 |
| R2 | −9.10649E−01 | −2.47970E−06 | −3.79360E−08 | 2.49600E−08 | −1.98790E−09 |
| R3 | −5.64462E+00 | 6.61890E−06 | −7.36310E−07 | 5.26440E−08 | −2.41020E−09 |
| R4 | 3.31910E+01 | −5.01970E−05 | 3.65120E−06 | −1.47270E−07 | 2.61990E−09 |
| R5 | −2.92582E+01 | −3.98820E−05 | 2.50410E−06 | −6.44690E−08 | −8.34300E−10 |
| R6 | −7.42951E+01 | 7.20420E−06 | −9.95630E−07 | 8.78120E−08 | −4.53430E−09 |
| R7 | −1.72761E−01 | 9.15710E−05 | −2.04490E−05 | 2.94880E−06 | −2.40690E−07 |
| R8 | 3.79838E+00 | −6.04260E−05 | 1.11580E−05 | −1.14290E−06 | 5.42220E−08 |
| R9 | −5.09801E+00 | −1.15920E−04 | 3.11900E−05 | −4.16340E−06 | 2.76970E−07 |
| R10 | −7.81895E−01 | 2.92210E−05 | −4.48610E−06 | 3.65000E−07 | −1.57010E−08 |

| | | Aspheric surface |
|---|---|---|
| | Conic | coefficients |
| | k | A20 |
| Rp1 | −6.06571E+00 | 7.06740E−15 |
| Rp2 | 0.00000E+00 | 0.00000E+00 |
| R1 | −2.46309E+00 | 5.07580E−11 |
| R2 | −9.10649E−01 | 4.74920E−11 |
| R3 | −5.64462E+00 | 5.31870E−11 |
| R4 | 3.31910E+01 | 1.91120E−12 |
| R5 | −2.92582E+01 | 6.34920E−11 |
| R6 | −7.42951E+01 | 1.02520E−10 |
| R7 | −1.72761E−01 | 8.26210E−09 |
| R8 | 3.79838E+00 | −6.97400E−10 |
| R9 | −5.09801E+00 | −7.21010E−09 |
| R10 | −7.81895E−01 | 2.82460E−10 |

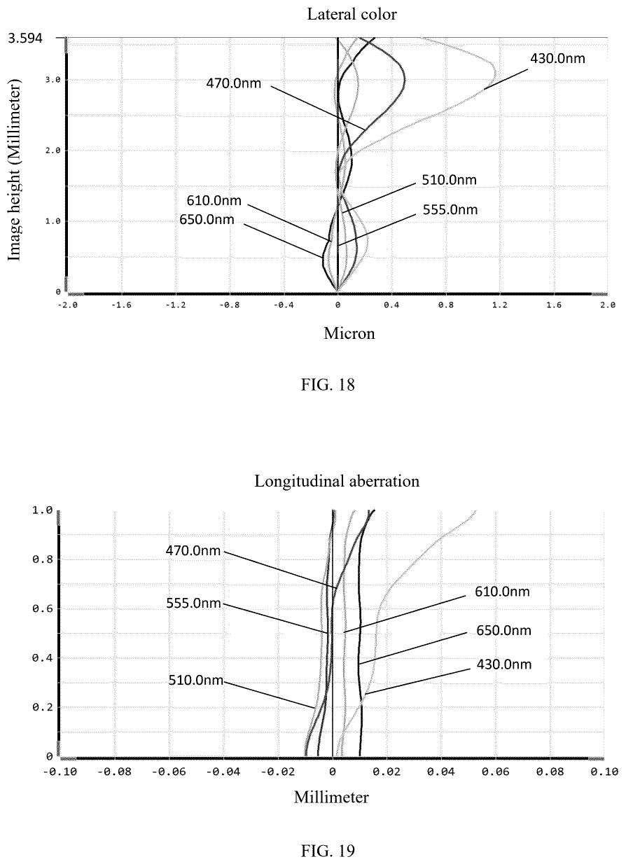

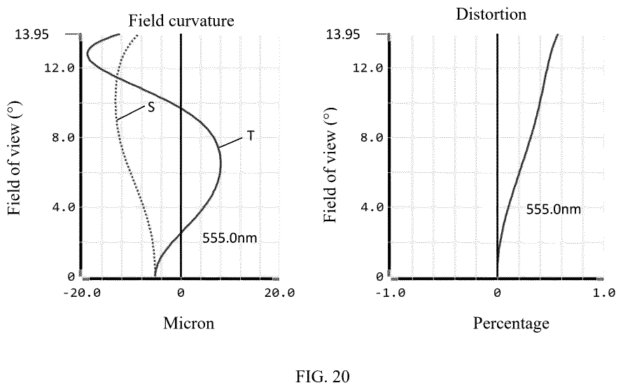

FIG. 18 and FIG. 19 illustrate a lateral color and a longitudinal aberration of the camera optical lens 50 according to the Fifth Embodiment after light with wavelengths of 650.0 nm, 610.0 nm, 555.0 nm, 510.0 nm, 470.0 nm, and 430.0 nm passing through the camera optical lens 50, respectively. FIG. 20 schematically illustrates a field curvature and a distortion of the camera optical lens 50 after light with a wavelength of 555.0 nm passing through the camera optical lens 50 according to the Fifth Embodiment. A field curvature S in FIG. 20 is a field curvature in a sagittal direction, and Tis a field curvature in a tangential direction.

It can be derived, according to Table 16, that the Fifth Embodiment satisfies the conditions.

In the embodiment, an entrance pupil diameter (ENPD) of the camera optical lens 50 in the first state is 7.252 mm, an image height IH of 1.0H is 3.594 mm, and a diagonal field of view FOV is 27.90°. Thus, the camera optical lens 50 can meet the requirements of long focal lengths, high magnification, and miniaturization while having excellent optical characteristics.

Table 16 various values in the First Embodiment, Second Embodiment, Third Embodiment, Fourth Embodiment, and Fifth Embodiment corresponding to parameters in the above conditions

| Parameters and | First | Second | Third | Fourth | Fifth |
|---|---|---|---|---|---|
| Conditions | Embodiment | Embodiment | Embodiment | Embodiment | Embodiment |
| fA*IH/TTL | 1.98 | 1.91 | 1.91 | 2.15 | 2.04 |
| Lp/TTL | 0.35 | 0.30 | 0.25 | 0.40 | 0.35 |
| Rp1/Rp2 | 0.35 | 0.00 | 0.70 | 1.10 | 0.70 |
| (R9 + R10)/ | 11.00 | 30.12 | 20.97 | 3.00 | 14.98 |
| (R9 − R10) | | | | | |
| (d1 + d3 + d5)/ | 2.99 | 2.63 | 2.40 | 2.40 | 2.94 |
| (d7 + d9) | | | | | |
| fA | 14.383 | 14.370 | 14.376 | 14.376 | 14.383 |
| fp1 | 57.808 | 46.351 | 55.913 | 114.598 | 69.544 |
| f1 | −11.400 | −10.181 | −8.315 | −9.125 | −11.347 |
| f2 | 5.779 | 5.510 | 4.974 | 5.058 | 5.725 |
| f3 | −23.546 | −12.496 | −14.576 | −217.224 | −25.784 |
| f4 | 31.444 | 18.382 | 15.759 | 21.967 | 35.859 |
| f5 | −59.939 | 290.346 | 7108.135 | −15.685 | −123.491 |
| FNO | 1.98 | 1.98 | 1.98 | 1.98 | 1.98 |
| TTL | 26.134 | 26.993 | 27.000 | 23.977 | 25.244 |
| IH | 3.594 | 3.594 | 3.594 | 3.594 | 3.594 |
| FOV | 27.88° | 27.86° | 27.88° | 27.88° | 27.90° |

Those skilled in the art shall understand that the embodiments described above are specific embodiments for implementing the present disclosure. In practice, various changes may be made to these embodiments in form and in detail without departing from the spirit and scope of the disclosure.

What is claimed is:

1. A camera optical lens, comprising, from an object side to an image side in sequence, a first prism with a positive refractive power, a first lens with a negative refractive power, a second lens with a positive refractive power, a third lens with a negative refractive power, a fourth lens with a positive refractive power, and a fifth lens;
wherein a reflective surface is provided between an object side surface and an image side surface of the first prism, and the first lens, the second lens, the third lens, the fourth lens, and the fifth lens form a lens assembly movable and adjustable along an optical axis of the camera optical lens, allowing the camera optical lens switchable between a first state and a second state;
wherein the camera optical lens has a maximum focal length in the first state and has a minimum focal length in the second state; and
wherein the camera optical lens satisfies the following conditions:
$$1.9 \leq fA * IH / TTL \leq 2.2 ;$$
$$0.25 \leq Lp / TTL \leq 0 \text{.41} ;$$
$$0. \leq Rp 1 / Rp 2 \leq 1.11 ; and$$
$$3. \leq ( R 9 + R 10 ) / ( R 9 - R 10 ) \leq 30 \text{.20} ;$$
wherein
fA represents a focal length of the camera optical lens in the first state;
IH represents an image height of 1.0H of the camera optical lens;
Lp represents a distance, along the optical axis, between a surface of a lens closest to the object side and a surface of a lens closest to the image side in the first state of the camera optical lens;
Rp1 represents a curvature radius of the object side surface of the first prism;
Rp2 represents a curvature radius of the image side surface of the first prism;
R9 represents a curvature radius of an object side surface of the fifth lens;
R10 represents a curvature radius of an image side surface of the fifth lens; and
TTL represents a total track length of the camera optical lens.

2. The camera optical lens according to claim 1, further satisfies the following condition:
$$2. 40 \leq ( d 1 + d 3 + d 5 ) / ( d 7 + d 9 ) \leq 3. ;$$
wherein
d1 represents an on-axis thickness of the first lens;
d3 represents an on-axis thickness of the second lens;
d5 represents an on-axis thickness of the third lens;
d7 represents an on-axis thickness of the fourth lens; and
d9 represents an on-axis thickness of the fifth lens.

3. The camera optical lens according to claim 1, wherein the object side surface of the first prism is convex in a paraxial region, and the camera optical lens further satisfies the following conditions:
$$3.22 \leq fp 1 / fA \leq 7.98 ; and$$
$$0.322 \leq dp 1 / TTL \leq 0.363$$
wherein
fp1 represents a focal length of the first prism; and
dp1 represents a sum of an on-axis distance between the object side surface of the first prism and the reflective surface and an on-axis distance between the reflective surface and the image side surface of the first prism.

4. The camera optical lens according to claim 1, wherein an object side surface of the first lens is convex in a paraxial region, and an image side surface of the first lens is concave in the paraxial region;
wherein the camera optical lens further satisfies the following conditions:
$$- 0.8 \leq f 1 / fA \leq - 0.57 ;$$
$$2.83 \leq ( R 1 + R 2 ) / ( R 1 - R 2 ) \leq 3.48 ; and$$
$$0.029 \leq d 1 / TTL \leq 0.06 ;$$
wherein
f1 represents a focal length of the first lens;
R1 represents a curvature radius of an object side surface of the first lens;
R2 represents a curvature radius of an image side surface of the first lens; and
d1 represents an on-axis thickness of the first lens.

5. The camera optical lens according to claim 1, wherein an object side surface of the second lens is convex in a paraxial region, and an image side surface of the second lens is concave in the paraxial region;
wherein the camera optical lens further satisfies the following conditions:
$$0.34 \leq f 2 / fA \leq 0.41 ;$$
$$- 0.96 \leq ( R 3 + R4 ) / ( R 3 - R 4 ) \leq - 0.67 ; and$$
$$0.067 \leq d 3 / TTL \leq 0.0 \; 84 ;$$
wherein
f2 represents a focal length of the second lens;
R3 represents a curvature radius of the object side surface of the second lens;
R4 represents a curvature radius of the image side surface of the second lens; and
d3 represents an on-axis thickness of the second lens.

6. The camera optical lens according to claim 1, further satisfies the following conditions:
$$- 15.12 \leq f 3 / fA \leq - 0.86 ;$$
$$- 1.74 \leq ( R 5 + R 6 ) / ( R 5 - R 6 ) \leq 2.02 ; and$$
$$0.048 \leq d 5 / TTL \leq 0.0 \; 78 ;$$
wherein
f3 represents a focal length of the third lens;
R5 represents a curvature radius of the object side surface of the third lens;
R6 represents a curvature radius of an image side surface of the third lens; and
d5 represents an on-axis thickness of the third lens.

7. The camera optical lens according to claim 1, wherein the object side surface of the fourth lens is convex in a paraxial region, and the image side surface of the fourth lens is concave in the paraxial region;
wherein the camera optical lens further satisfies the following conditions:
$$1.09 \leq f 4 / fA \leq 2.5 ;$$
$$- 10.76 \leq ( R 7 + R 8 ) / ( R 7 - R 8 ) \leq - 2.02 ; and$$
$$0.037 \leq d 7 / TTL \leq 0.0 \; 42 ;$$
wherein
f4 represents a focal length of the fourth lens;
R7 represents a curvature radius of the object side surface of the fourth lens;
R8 represents a curvature radius of an image side surface of the fourth lens; and
d7 represents an on-axis thickness of the fourth lens.

8. The camera optical lens according to claim 1, wherein an object side surface of the fifth lens is convex in a paraxial region, and an image side surface of the fifth lens is concave in the paraxial region;
wherein the camera optical lens further satisfies the following conditions:
$$- 8.59 \leq f 5 / fA \leq 494.45 ; and$$
$$0.027 \leq d 9 / TTL \leq 0.0 \; 51 ;$$
wherein
f5 represents a focal length of the fifth lens; and
d9 represents an on-axis thickness of the fifth lens.

9. The camera optical lens according to claim 1, wherein the first prism is made of glass.
